(19) United States
(12) Patent Application Publication
(10) Pub. No.: US 2002/0198740 A1
(43) Pub. Date: Dec. 26, 2002

(54) Intelligent data retrieval system and method

(76) Inventors: Linda L. Roman, Boca Raton, FL (US); Vincient Colwell, Martinez, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/886,310

(22) Filed: Jun. 21, 2001

(51) Int. Cl. G06F 17/60

(52) U.S. Cl. 705/3

(57) ABSTRACT

A system, method, computer system, and computer readable medium for automatically and without operator intervention communicating at least one patient data point from a patient data collection system to a remote patient data storage system. The system provides for automatically communicating at least one patient data point through a network. This system includes a patient data collection system and a remote patient data storage system. The patient data collection system is capable of communicatively coupling with the network. The remote patient data storage system is capable of communicatively coupling with the network, is remotely located from the patient data collection system, and is capable of communicatively coupling with the patient data collection system via the network.

### CROSS-REFERENCE TO RELATED APPLICATIONS

This application is related to U.S. Pat. No. 5,987,519 entitled, “TELEMEDICINE SYSTEM USING VOICE VIDEO AND DATA ENCAPSULATION AND DE-ENCAPSULATION FOR COMMUNICATING MEDICAL INFORMATION BETWEEN CENTRAL MONITORING STATIONS AND REMOTE PATIENT MONITORING STATIONS,” filed on Sep. 19, 1997, which is entirely incorporated herein by reference.

### FIELD OF INVENTION

This invention relates to transfer and storage of medical measurement data in a remote operations scenario and, more particularly, to an automatic data transfer system and method.

### BACKGROUND

Generally, “telemedicine” is a term used to describe a type of patient care, which involves monitoring of a patient's condition by a healthcare worker located at a healthcare facility, which is remote with respect to the location of the patient. Telemedicine, if adequately employed, is capable of providing enormous benefits to society. One such benefit is that patients can be examined without having to travel to a healthcare facility. This feature is particularly important for patients who live in remote areas who may not be able to easily travel to the nearest healthcare facility, or who need to be examined by a healthcare worker located far away from the patient, in another state, for example.

Another benefit of telemedicine is that it is capable of allowing a patient to be examined more often than would be possible if the patient were required to travel to a healthcare facility due to the ease with which it can be administered. For example, if a patient's condition requires that measurements be taken several times a day, it would be impractical for the patient to travel to and from a healthcare facility each time a measurement needs to be taken. It probably would be necessary for the patient to be admitted to the healthcare facility. The use of telemedicine could allow these measurements to be taken at the patient's home while the healthcare worker observed the patient or the measurement data from the healthcare facility.

Another benefit of telemedicine is that it allows a patient to be examined in a timelier manner than if the patient was required to travel to the healthcare facility. This is important in urgent situations, such as when a patient's condition becomes critical and emergency procedures must be taken immediately.

The current approaches to technology-assisted patient care have been under the assumption that “one-size -fits-all.” The results have been inconclusive. Assessment of these efforts has been subjective as has patient outcomes and progress towards a specific goal. These goals are not typically standardized and often fluctuate from one care provider to the next based on their interpretations of accepted guidelines.

The telemedicine based patient care management tools that have been developed to date are beginning to recognize that current methods and processes do not address the needs of the diverse pool of patients or the needs of the various types of patient care organizations.

Medical measurement device manufacturers have developed vertically integrated data collection systems specific to particular products. Management of the incoming data are rarely part of the system operation. Moreover, data transfer and storage are optimized for the medical device. The developers of these systems have extensive experience with the medical measurement devices and systems but normally do not have experience in data and communications systems. The resulting systems are sub-optimized for developing information about the patient condition in a way that can be effectively used to affect the course of treatment.

Thus, a heretofore unaddressed need exists in the industry to address the aforementioned deficiencies and inadequacies.

### SUMMARY OF THE INVENTION

The present invention provides, among other things, a system, method, computer system, and computer readable medium for automatically communicating at least one patient data point from a patient data collection system to a remote patient data storage system without operator intervention.

An embodiment of the present invention provides a system for automatically communicating at least one patient data point through a network. This system includes a patient data collection system and a remote patient data storage system. The patient data collection system is capable of communicatively coupling with the network. The remote patient data storage system is capable of communicatively coupling with the network, is remotely located from the patient data collection system, and is capable of communicatively coupling with the patient data collection system via the network.

Another embodiment provides for a method for automatically communicating at least one patient data point from a patient data collection system, where the patient data collection system is capable of communicatively coupling with a remote patient data storage system through a network. The method includes communicating the at least one patient data point automatically to the remote patient data storage system from the patient data collection system.

Still another embodiment provides for a method for automatically communicating at least one patient data point from a patient data collection system where the patient data collection system is capable of communicatively coupling with a remote patient data storage system through a network. The method includes storing the at least one patient data point automatically in the remote patient data storage system.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 illustrates a high-level block diagram that is an overview of the intelligent data retrieval system and method of use in accordance with the present invention.

FIG. 2A illustrates a computer system that may be employed by the patient data collection system as shown in FIG. 1.

FIG. 2B illustrates a high-level flow chart of the patient data collection system program shown in FIG. 2A.

FIG. 3A illustrates a computer system that may be employed by the remote patient data storage system as shown in FIG. 1.

FIG. 3B illustrates a high-level flow chart of the remote patient data storage system shown in FIG. 3A.

FIG. 4 illustrates a more detailed block diagram of the intelligent data retrieval system and method of use as shown in FIG. 1.

FIG. 5 illustrates a flow chart of an embodiment of the intelligent data retrieval system and method of use as shown in FIG. 1.

### DETAILED DESCRIPTION

To address the aforementioned deficiencies and inadequacies, embodiments of the present invention are directed towards a system, method, computer system, and computer readable medium that is capable of automatically communicating medical sensor measurement data to a remote storage system without the need for an operator (e.g. care provider, patient, or an individual assisting the patient) to intervene (e.g. request or actively send the patient data).

Embodiments of the present invention can be used as an integrated part of a telemedicine system to automatically and without operator intervention communicate patient medical sensor measurement data (one or more patient data points) generated by a medical sensor (e.g. medical device) that is accessible to the patient (e.g. located at the home of the patient) but at a location remote from the care provider.

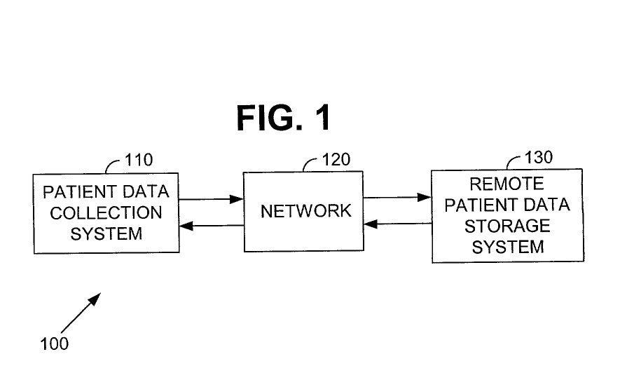

FIG. 1 illustrates an embodiment of the intelligent data retrieval (IDR) system 100 of the present invention that provides automatic communication and remote and automatic storage of patient data as measured by a medical sensor that is accessible to the patient but remote from the care provider. The IDR system 100 has at least two interconnected systems: the patient data collection system 110 and the remote patient data storage system 130. The patient data collection system 110 and the remote patient data storage system 130 can be communicatively coupled using a network 120. The network 120 can include, for example, but not limited to, a public switched telephone network (PSTN), the internet, cellular network, a synchronous transfer mode (ATM), local area network (LAN), wide area network, or combinations thereof. Patient data can be encapsulated in a communication protocol (e.g. TCP/IP) that is appropriate for the network 120 being used. It will be apparent to those skilled in the art that many communication protocols can be used with embodiments of the present invention.

Communicatively couple, as used hereinafter, means to establish communication between or among the various systems, etc. of the IDR system 100. Communicate or communication as used herein can mean, but is not limited to, send, transfer, or any other term that connotes the movement of patient data from a medical sensor to a patient data collection system 110, movement of patient data from a patient data collection system 110 to a remote patient data storage system 130, etc. Automatically or automatic, as used to describe to communicate, communication, etc. and store, storing, etc., means to perform the operation (e.g. communicate or store) without intervention by an operator. A non-limiting illustrative example would include automatically communicating patient data, where such operation (communication) is performed without the patient, someone assisting the patient, care provider, etc. from actively (e.g. pushing a button or initiating a command) causing the operation to occur. In other words, the patient data is communicated without the need for the patient, someone assisting the patient, care provider, etc. from having to do or execute an action. The patient data collection system 100 communicates (automatically) the patient data to the remote patient data storage system 130 after (e.g. at a predetermined time period) the occurrence of a predetermined event (discussed hereinafter).

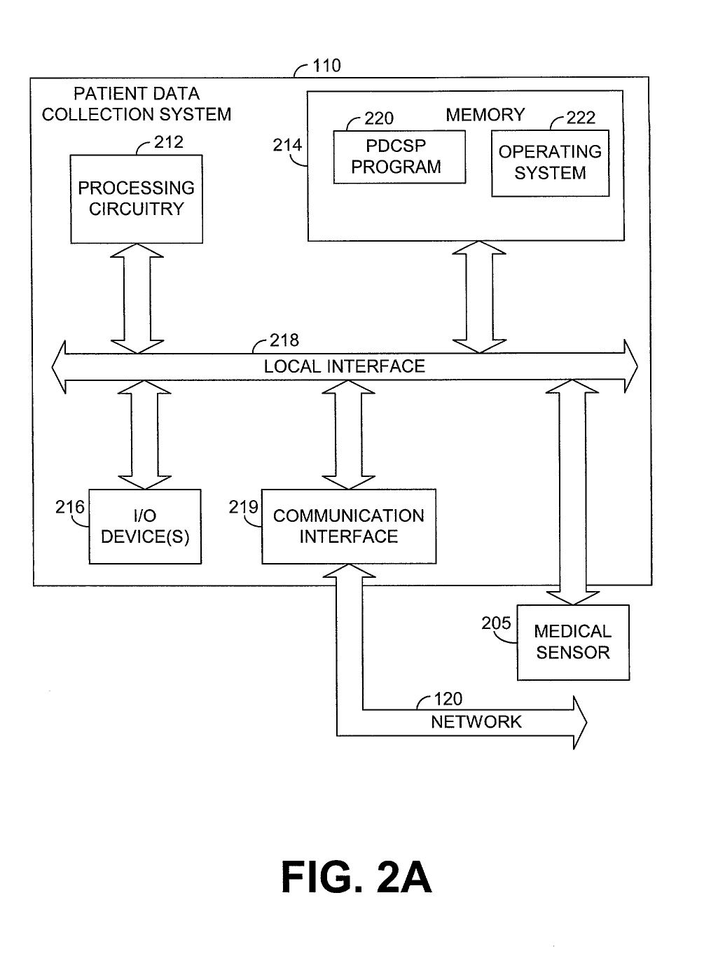

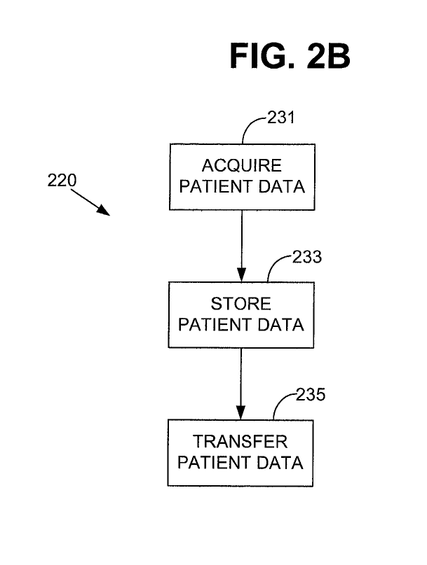

The patient data collection system 110 includes a computer system that is capable of communicatively coupling with, but not limited to, a medical sensor 205 and a network 120. The patient data collection system 110 includes a patient data collection system program 220 (hereinafter PDCSP 220) that can be implemented in software (e.g., firmware), hardware, or a combination thereof. The PDCPSP 220 can be implemented in an executable program, and is executed by a special or general purpose digital computer, such as a personal computer (PC; IBM-compatible, Apple-compatible, or otherwise), workstation, minicomputer, or mainframe computer. An example of a general purpose computer that can implement PDCPSP 220 of the the patient data collection system 110 that is part of IDR system 100 is shown in FIG. 2A.

Generally, in terms of hardware architecture, as shown in FIG. 2A, the patient data collection system 110 includes a processor 212, memory 214, and one or more input and/or output (I/O) devices 216 (or peripherals) that are communicatively coupled via a local interface 218. The local interface 218 can be, for example, but not limited to, one or more buses or other wired or wireless connections, as is known in the art. The local interface 218 may have additional elements, which are omitted for simplicity, such as controllers, buffers (caches), drivers, repeaters, and receivers, to enable communications. Further, the local interface 218 may include address, control, and/or data connections to enable appropriate communications among the aforementioned components. The local interface 218 is communicatively coupled to a communication interface 219 that functions to communicatively couple with one or more networks 120.

The processor 212 is a hardware device for executing software that can be stored in memory 214. The processor 212 can be any custom made or commercially available processor, a central processing unit (CPU) or an auxiliary processor among several processors associated with the patient data collection system 110, and a semiconductor based microprocessor (in the form of a microchip) or a macroprocessor. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 214 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 214 may incorporate electronic, magnetic, optical, and/or other types of storage media. Note that the memory 214 can have a distributed architecture, where various components are situated remote from one another, but can be accessed by the processor 212.

The software in memory 214 may include one or more separate programs, each of which comprises an ordered listing of executable instructions for implementing logical functions. In the example of FIG. 2, the software in the memory 214 includes, but is not limited to, patient data collection system program 220 (hereinafter PDCSP 220) LPDCPSP 220, and a suitable operating system (O/S) 222. A nonexhaustive list of examples of suitable commercially available operating systems 222 is as follows: a Windows operating system from Microsoft Corporation, a Netware operating system available from Novell, Inc., or a UNIX operating system, which is available for purchase from many vendors, such as Hewlett-Packard Company, Sun Microsystems, Inc., and AT&T Corporation. The operating system 222 essentially controls the execution of other computer programs, such as the PDCSP 220, and provides scheduling, input-output control, file and data management, memory management, and communication control and related services.

The PDCSP 220 can be a source program, executable program (object code), script, or any other entity comprising a set of instructions to be performed. When a source program, then the program needs to be translated via a compiler, assembler, interpreter, or the like, which may or may not be included within the memory 214, so as to operate properly in connection with the O/S 222. Furthermore, the patient data collection system programs 224 can be written as (a) an object oriented programming language, which has classes of data and methods, or (b) a procedure programming language, which has routines, subroutines, and/or functions, for example, but not limited to, C, C++, Pascal, Basic, Fortran, Cobol, Perl, Java, and Ada.

The I/O devices 216 may include input devices, for example, but not limited to, a keyboard, mouse, scanner, microphone, etc. Furthermore, the I/O devices 216 may also include output devices, for example, but not limited to, a printer, display, etc. The communication interface 219 may include devices that communicate both inputs and outputs, for instance but not limited to, a modulator/demodulator (modem; for accessing another device, system, or network), a radio frequency (RF) or other transceiver, a telephonic interface, a bridge, a router, etc.

If the patient data collection system 110 is a PC, workstation, or the like, the software in the memory 214 may further include a basic input output system (BIOS) (omitted for simplicity). The BIOS is a set of essential software routines that initialize and test hardware at startup, start the O/S 222, and support the transfer of data among the hardware devices. The BIOS is stored in ROM so that the BIOS can be executed when the patient data collection system 110 is activated.

When the patient data collection system 110 is in operation, the processor 212 is configured to execute software stored within the memory 214, to communicate data to and from the memory 214, and to generally control operations of the patient data collection system 110 pursuant to the software. The PDCSP 220 and the O/S 222, in whole or in part, but typically the latter, are read by the processor 212, perhaps buffered within the processor 212, and then executed.

When the PDCSP 220 is implemented in software, as is shown in FIG. 2A, it should be noted that the PDCSP 220 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The PDCSP 220 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where PDCSP 220 can be implemented in hardware, the PDCSP 220 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 2B illustrates a high-level flow chart of the PDCSP 220. Generally, the PDCSP 220 is capable of acquiring or receiving the patient data from the medical sensor 205, as shown in block 231. In addition, the PDCSP 220 is capable of storing the patient data in appropriate memory 214, as shown in block 233. Further, the PDCSP 220 is capable of communicatively coupling and automatically transmitting the patient data to a remote patient data storage system 130 via a network 120 without operator intervention. The PDCSP 220 is capable of automatically transmitting the patient data after an appropriate time period after completing the patient data measurements (e.g. two minutes). Alternatively, the patient data can be automatically transmitted at a predetermined time as determined by a care provider. The appropriate time period may be made in view of the medical sensor 205. In addition, other predetermined events can be used to initiate coupling with the network 120 such as, but not limited to, a certain number of measurements, time of day, or other indication that the patient data collection system 110 determines that the patient data measurement has been completed or that the patient data collection system 110 needs to communicate with the remote patient data storage system 130. In addition, the PDCSP 220 is capable of encapsulating the patient data in a communication protocol that is appropriate for the network 120 being used.

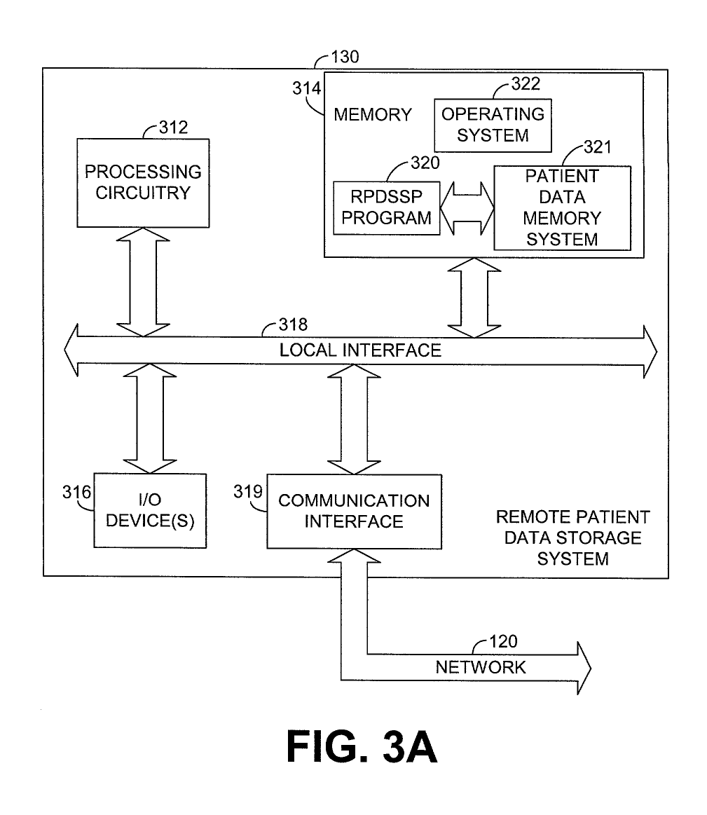

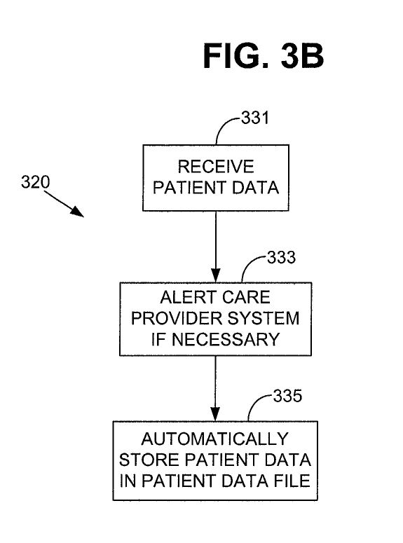

The remote patient data storage system 130, as shown in FIG. 1, includes a computer system 310 that is capable of communicatively coupling with, but not limited to, a network 120, as described previously. The remote patient data storage system 130 includes a remote patient data storage system program 320 (hereinafter RPDSSP 320) that can be implemented in software (e.g., firmware), hardware, or a combination thereof. The RPDSSP 320 can be implemented in software, as an executable program, and is executed by a special or general purpose digital computer, such as a personal computer (PC; IBM-compatible, Apple-compatible, or otherwise), workstation, minicomputer, or mainframe computer. An example of a general purpose computer that can implement the RPDSSP 320 of the remote patient data storage system 130 that is part of the IDR system 100 is shown in FIG. 3A.

Generally, in terms of hardware architecture, as shown in FIG. 3A, the remote patient data storage system 130 includes a processor 312, memory 314, and one or more input and/or output (I/O) devices 316 (or peripherals) that are communicatively coupled via a local interface 318. The local interface 318 can be, for example, but not limited to, one or more buses or other wired or wireless connections, as is known in the art. The local interface 318 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 312 is a hardware device for executing software that can be stored in memory 314. The processor 312 can be any custom made or commercially available processor, a central processing unit (CPU) or an auxiliary processor among several processors associated with the remote patient data storage system 130, and a semiconductor based microprocessor (in the form of a microchip) or a macroprocessor. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 314 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 314 may incorporate electronic, magnetic, optical, and/or other types of storage media. Note that the memory 314 can have a distributed architecture, where various components are situated remote from one another, but can be accessed by the processor 312. In addition, memory 314 may include a patient data memory system 321 that functions to store patient data in patient data files. The patient data memory system 321 can include, but is not limited to, a patient data base system or any of the aforementioned memory 314 that are capable of storing patient data in patient data files.

The software in memory 314 may include one or more separate programs, each of which comprises an ordered listing of executable instructions for implementing logical functions. In the example of FIG. 3, the software in the memory 314 includes, but is not limited to, RPDSSP 320 and a suitable operating system (O/S) 322. A nonexhaustive list of examples of suitable commercially available operating systems 322 is as follows: a Windows operating system from Microsoft Corporation, a Netware operating system available from Novell, Inc., or a UNIX operating system, which is available for purchase from many vendors, such as Hewlett-Packard Company, Sun Microsystems, Inc., and AT&T Corporation. The operating system 322 essentially controls the execution of other computer programs, such as the RPDSSP 320, and provides scheduling, input-output control, file and data management, memory management, and communication control and related services.

The RPDSSP 320 can be a source program, executable program (object code), script, or any other entity comprising a set of instructions to be performed. When a source program, then the program needs to be translated via a compiler, assembler, interpreter, or the like, which may or may not be included within the memory 314, so as to operate properly in connection with the O/S 322. Furthermore, the RPDSSP 320 can be written as (a) an object oriented programming language, which has classes of data and methods, or (b) a procedure programming language, which has routines, subroutines, and/or functions, for example, but not limited to, C, C++, Pascal, Basic, Fortran, Cobol, Perl, Java, and Ada.

The I/O devices 316 may include input devices, for example, but not limited to, a keyboard, mouse, scanner, microphone, etc. Furthermore, the I/O devices 316 may also include output devices, for example, but not limited to, a printer, display, etc. The communication interface 319 may include devices that communicate both inputs and outputs, for instance, but not limited to, a modulator/demodulator (modem; for accessing another device, system, or network), a radio frequency (RF) or other transceiver, a telephonic interface, a bridge, a router, etc.

If the remote patient data storage system 130 is a PC, workstation, or the like, the software in the memory 314 may further include a basic input output system (BIOS) (omitted for simplicity). The BIOS is a set of essential software routines that initialize and test hardware at startup, start the O/S 322, and support the transfer of data among the hardware devices. The BIOS is stored in ROM so that the BIOS can be executed when the remote patient data storage system 130 is activated.

When the remote patient data storage system 130 is in operation, the processor 312 is configured to execute software stored within the memory 314, to communicate data to and from the memory 314, and to generally control operations of the remote patient data storage system 130 pursuant to the software. The RPDSSP 320 and the O/S 322, in whole or in part, but typically the latter, are read by the processor 312, perhaps buffered within the processor 312, and then executed.

When the RPDSSP 320 is implemented in software, as is shown in FIG. 3A, it should be noted that the RPDSSP 320 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. One non-limiting illustrative example includes, but is not limited to, a remote patient data base system. The RPDSSP 320 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the RPDSSP 320 can be implemented in hardware, the RPDSSP 320 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

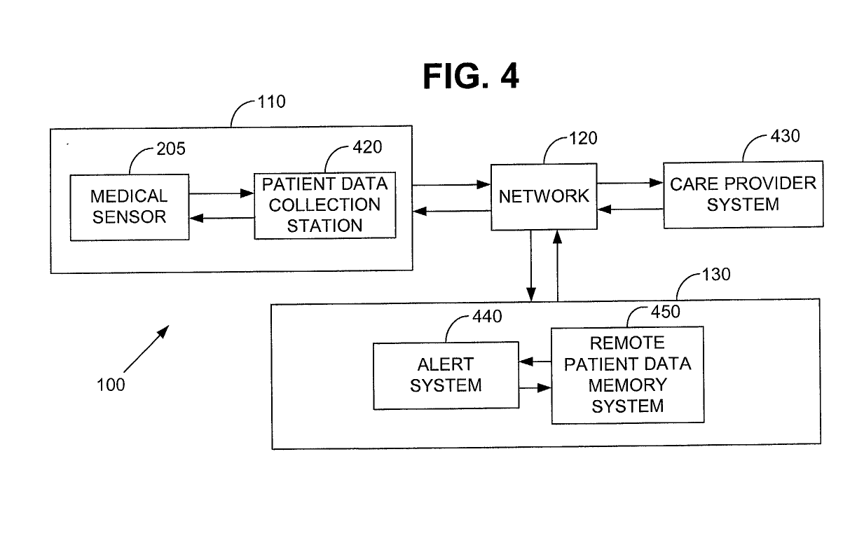

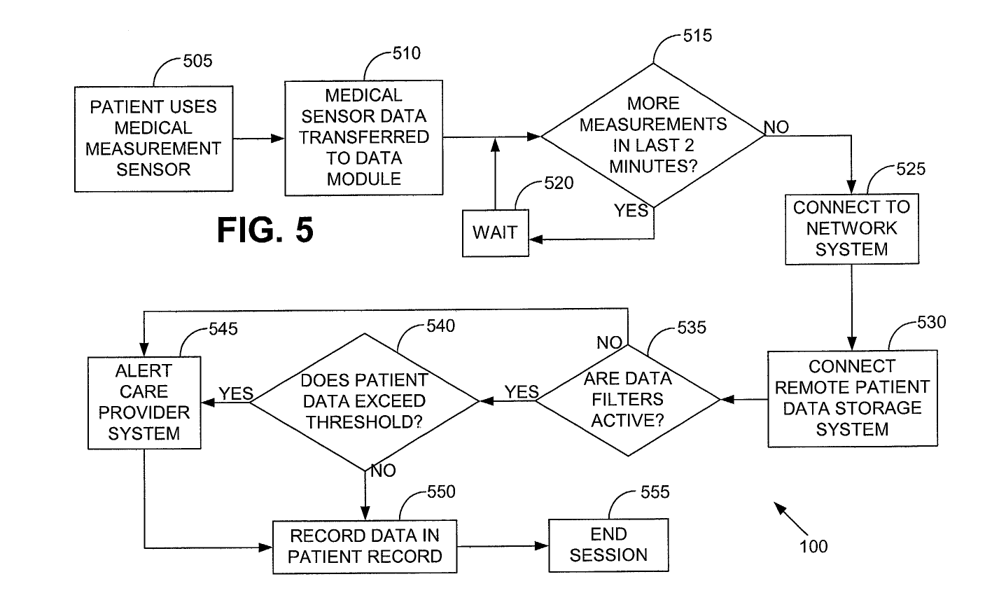

FIG. 3B illustrates a high-level flow chart of the RPDSSP 320. Generally, the RPDSSP 320 is capable of receiving patient data from the patient data collection system 110 via the network 120, as shown in block 331. If needed, the RPDSSP 320 is capable of alerting a care provider system, as shown in block 333 (described in more detail in FIGS. 4 and 5). In addition, the RPDSSP 320 is capable of automatically storing, without operator intervention, the patient data in appropriate memory 314, which may include a patient data memory system 321 (FIG. 3A), as shown in block 335. The RPDSSP 320 is capable of automatically storing the patient data in a specific patient data file for a specific medical sensor 205. One skilled in the art would understand that the patient data file can be organized in an appropriate manner as determined by a care provider or other organization.

FIG. 4 is a block diagram that provides a more detailed illustration of an embodiment of the present invention as illustrated in FIG. 1. The IDR system 100 is capable of automatically communicating and remotely storing patient data without operator intervention. Operator intervention does not include the patient or someone assisting the patient from initiating, ending, or otherwise affecting the use of a medical sensor 205. An embodiment of the IDR system 100 includes, but is not limited to, a patient data collection system 100, a remote patient data storage system 130, and a care provider system 430. The patient data collection system 110, remote patient data storage system 130, and the care provider system 430 are communicatively coupled via the network 120. The patient data collection system 110 includes, but is not limited to, one or more medical sensors 205 and one or more patient data collection stations 420. The patient data collection station 420 is capable of communicatively coupling with the network 120 and one or more medical sensors 205 and includes a PDCSP 220. The PDCSP 220 of the patient data collection system 110 is capable of performing routine tasks such as, but not limited to, medical sensor management and patient data collection station management. In addition, the PDCSP 220 is capable of performing tasks such as, but not limited to, patient data storage and management, preparing patient data in an appropriate communication protocol, and other functions that enable the automatic communication of patient data to the remote patient data storage system 130 from the patient data collection system 110 without operator intervention.

The remote patient data storage system 130 includes, but is not limited to, a remote patient data memory system 405 and an alert system 440. The remote patient data storage system 130 can communicatively couple with the network 120. The remote patient data memory system 450 can communicate with the alert system 440 and vice versa. The remote patient data memory system 450 stores patient data in memory 314, as discussed above with reference to FIG. 3A. In addition, the remote patient data memory system 450 includes the RPDSSP 324. The RPDSSP 324 is capable of performing routine tasks such as, but not limited to, remote patient data memory system management, alert system management, and other functions that enable the automatic communication of patient data between the remote patient data storage system 130 and the patient data collection system 120 without operator intervention. The alert system 440 functions to alert the care provider system 430 when patient data (e.g. one or more patient data points or an average of a predetermined number of patient data points) is not a predetermined value. The alert system 440 includes data filters, which can be set to predetermined values. The values indicate acceptable values of patient data that do not require alerting the care provider system 430 (discussed below). An illustrative example includes a situation where patient data indicates a blood pressure value that is above a predetermined value of the data filter. In such a case, the alert system 440 alerts the care provider system 430 that the patient that the patient data corresponds to has a blood pressure reading that is outside of a predetermined range.

The patient data collection system 110 of the IDR system 100 is capable of supporting an open architecture for use with a variety of medical sensors 205. A plurality of medical sensors 205 can be supported on the patient data collection system 110, with the preferred embodiment capable of supporting two or more medical sensors 205. The medical sensors 205 should be capable of electronic data transfer via a data connection (e.g. serial) or other appropriate data connection that functions to transfer data. Specific features of the medical sensors 205 determine the extent and breadth of the interface available. More sophisticated medical sensors 205 provide a richer suite of features. The following is a nonlimiting list of medical sensor 205 categories that can be used with the IDS system 100: digital weight scale, a device to measure body weight; blood pressure, a device to measure blood pressure, using an inflatable arm cuff; coagulation meter, a device to measure blood coagulation (prothrombin time and INR) using a finger prick blood sample; temperature, a device to measure temperature either orally or tympanically; integrated multifunction monitor, a single monitor to measure blood pressure, blood oxygen saturation, pulse rate, and temperature; glucometer, a device to measure blood glucose level using a finger prick blood sample; pulse oximeter, a device to measure blood oxygen saturation levels and heart rate; uterine activity/fetal heart monitor, a device to measure uterine fetal activity and fetal heart rate; spirometer/peak flow meter, a device to measure pulmonary function; multifunction test unit, a device to perform a variety of blood tests; eletrocardiograph unit, a device to measure cardiac activity.

FIG. 5 provides a detailed flowchart of one of a number of possible embodiments of the IDR system 100 illustrated in FIGS. 1-4. Initially, the IDR system 100 remains in a standby condition until activated. Generally, the patient identifies themselves by starting to use the medical measurement sensor 305, as shown in block 510. The patient data is transferred to the patient data collection station 420 from the medical sensor 205, as indicated in block 306. In decisional block 515, the IDR system 100 determines if more measurements have been received in the last two minutes or other appropriate time period as predetermined by a care provider in view of the medical sensor 205. In addition, other predetermined events can be used to initiate coupling with the network 120 such as, but not limited to, a certain number of measurements, time of day, or other indication that the patient data collection system 110 determines that the patient data measurement has been completed or that the patient data collection system 110 needs to communicate with the remote patient data storage system 130. If the determination is “yes,” the IDR system 100 waits, as shown in block 520. If the determination is “no,” the IDR system 100 connects to the network 120, as shown in block 525. Next, as indicated in block 530, the network communicatively couples with the remote patient data storage system 130. The IDR system 100 hardware and software are capable of providing features that ensure data security and patient privacy during patient data transfer. For example, the connection between the network 120 and the remote patient data storage system 130 can be encrypted or encoded in an appropriate manner. Generally, the IDR system 100 automatically and without operator intervention communicates (e.g. sends or transfers) the patient data after a predetermined inactivity time period after a medical sensor 205 is used.

The IDR system 100 is capable of determining if any data filters are active, as shown in decision block 535. The IDR system 100 allows for the implementation of programmable data filters. The programmable filters can be set per medical sensor 203 and/or per patient. The data filter is capable of establishing high and/or low limits (alerts) for incoming data. These alerts can be sent to the care provider (e.g. physician or nurse) at the care provider system 430. The data filters can be set to check each medical sensor 205 measurement or be set to identify average value changes of acquired patient data. Additionally, data filters can also be used in combination when there are multiple medical sensors 205 being used. If the determination in block 535 is “no,” then the IDR system 100 alerts the care provider, as shown in block 545. If the determination in block 535 is “yes,” then IDR system 100 determines if one or more patient data points are not equal to a predetermined value (e.g. one or more values can be predetermined so that a predetermined value can equal a range of values) of one or more appropriate data filters, as shown in decisional block 540. If the determination in block 540 is “yes,” then the IDR system 100 alerts the care provider system 430, as shown in block 545. The care provider system 430 (e.g. care provider) then can take appropriate action. Alerts are linked to breaches in the high and/or low limits of the data filters. In block 540, if the determination is “no,” then the IDR system 100 records the patient data in the appropriate patient record 550 in the remote patient data storage system 130 and the session is subsequently ended, as shown in block 555.

Many variations and modifications may be made to the above-described embodiment(s) of the invention without departing substantially from the spirit and principles of the invention. All such modifications and variations are intended to be included herein within the scope of this disclosure and the present invention and protected by the following claims.

We claim at least the following:

1. A system for automatically communicating at least one patient data point through a network, comprising:
a patient data collection system that is capable of communicatively coupling with the network; and
a remote patient data storage system that is capable of communicatively coupling with the network, the remote patient data storage system being remotely located from the patient data collection system, and being capable of communicatively coupling with the patient data collection system via the network.

2. The system of claim 1, wherein the patient data collection system is capable of communicating the at least one patient data point automatically to the remote patient data storage system upon the occurrence of a predetermined event.

3. The system of claim 1, wherein the patient data collection system and the remote patient data storage system are capable of interacting to automatically communicate the at least one patient data point to the patient data storage system.

4. The system of claim 1, wherein the patient data collection system includes at least one medical sensor and at least one patient data collection station, wherein the medical sensor is capable of communicatively coupling with the patient data collection station and is capable of transferring data to the patient data collection station and wherein the patient data collection station is capable of communicatively coupling with at least one medical sensor and is capable of communicatively coupling with the network.

5. The system of claim 1, wherein the remote patient data storage system includes an alert system and a remote patient data memory system.

6. The system of claim 5, wherein the remote patient data memory system includes a remote patient data base system.

7. A method for automatically communicating at least one patient data point from a patient data collection system where the patient data collection system is capable of communicatively coupling with a remote patient data storage system through a network, comprising the step of communicating the at least one patient data point automatically to the remote patient data storage system from the patient data collection system.

8. The method of claim 7, wherein the step of communicating the at least one patient data point automatically to the remote patient data storage system from the patient data collection system includes, the step of communicating the at least one patient data point automatically to the remote patient data storage system from the patient data collection system upon the occurrence of a predetermined event.

9. The method of claim 8, wherein the step of communicating the at least one patient data point automatically to the remote patient data storage system from the patient data collection system upon the occurrence of a predetermined event includes, the step of communicating the at least one patient data point automatically to the remote patient data storage system from the patient data collection system after the patient data collection system determines that collection of the at least one patient data point is complete.

10. A method for automatically communicating at least one patient data point from a patient data collection system where the patient data collection system is capable of communicatively coupling with a remote patient data storage system through a network, comprising the step of storing the at least one patient data point automatically in the remote patient data storage system.

11. The method of claim 10, wherein the step of storing the at least one patient data point automatically in the remote patient data storage system includes the step of storing the at least one patient data point automatically in a remote patient data memory system.

12. The method of claim 10, wherein the step of storing the at least one patient data point automatically in the remote patient data storage system includes the step of storing the at least one patient data point automatically in a remote patient data base system.

13. The method of claim 10, further comprising the step of alerting a care provider system if the at least one patient data point is not a predetermined value.

14. A computer readable medium for automatically communicating at least one patient data point from a patient data collection system where the patient data collection system is capable of communicatively coupling with a remote patient data storage system through a network, comprising logic configured to communicate the at least one patient data point automatically to the remote patient data storage system from the patient data collection system.

15. A computer readable medium for automatically communicating at least one patient data point from a patient data collection system where the patient data collection system is capable of communicatively coupling with a remote patient data storage system through a network, comprising logic configured to store the at least one patient data point automatically in the remote patient data storage system.

16. A method for use in a computer system for automatically communicating at least one patient data point from a patient data collection system where the patient data collection system is capable of communicatively coupling with a remote patient data storage system through a network, comprising the step of communicating the at least one patient data point automatically to the remote patient data storage system from the patient data collection system.

17. A method for use in a computer system for automatically communicating at least one patient data point from a patient data collection system where the patient data collection system is capable of communicatively coupling with a remote patient data storage system through a network, comprising the step of storing the at least one patient data point automatically in the remote patient data storage system.
